(19) United States
(12) Patent Application Publication
(10) Pub. No.: US 2004/0247074 A1
(43) Pub. Date: Dec. 9, 2004

(54) Bone simulation analysis

(76) Inventor: Christian M. Langton, Yorkshire (GB)

Correspondence Address: STITES & HARBISON PLLC, 1199 NORTH FAIRFAX STREET, SUITE 900, ALEXANDRIA, VA, 22314, US

(21) Appl. No.: 10/492,525

(22) PCT Filed: Oct. 17, 2001
(86) PCT No.: PCT/GB02/04710

(30) Foreign Application Priority Data
Oct. 17, 2001 (GB) 0124947.3

(51) Int. Cl. G01N 23/06

(52) U.S. Cl. 378/54; 378/56

(57) ABSTRACT

A method of analysing a bone model, the bone model including an array of finite elements, the method including the steps of: i. simulating the application of a load to a selected plurality of the elements and ii. limiting the selected elements so that each moves an equal distance when the load application is simulated.

The present invention relates to a method of analysing a simulated bone and in particular analysing the strength or weakness of such a bone. The invention also encompasses an apparatus for carrying out such a method.

The present invention could be used to analyse a bone simulation for a wide variety of reasons, but one of the main reasons is to assess whether the bone is affected by osteoporosis and is therefore more likely to suffer a fracture.

Osteoporosis describes a period of asymptomatic bone loss with an associated skeletal fragility and increased risk of fracture. In the UK alone, the number of subjects suffering a fracture of the distal radius and proximal femur exceed 60,000 and 50,000 respectively, with an estimated cost of £940 million per annum. A quarter of these subjects die within 12 months, a quarter of those remaining never regain independent status. There is therefore an increasing need to identify subjects at risk of osteoporotic fracture in order to provide preventative clinical management.

Currently, the preferred method of assessing the risk of an osteoporosis related fracture is a measure of bone mineral density (BMD) by dual energy X-ray absorptiometry (DXA). BMD is utilised as a measure of mechanical integrity of the bone. It should be noted that BMD assessment provides an a real density measure, where the cross-sectional scan area is known but not the tissue thickness, providing units of g cm⁻². It is generally accepted that for fracture risk assessment of a particular bone, BMD measurement should be performed at that anatomical site, for example, BMD at the forearm provides the best prediction for distal radius fracture. However other factors contribute to the overall risk of fracture including anatomical geometry and the spatial distribution of bone.

Finite element analysis (FEA) is a widely used technique for the computer modelling of structures, usually large engineering structures, under mechanical loading.

A finite element is an individual regular shape within a number of nodes that has defined material properties (e.g. density, Young's modulus and Poisson's ratio, so that any applied load will give a predictable corresponding displacement. Elements are joined together at nodes along edges. Complex designs are made up as an assembly of nodes, called a mesh, to which restraints/constraints and loads may be applied.

During the computer analysis of the model, a series of simultaneous equations are set up which represent the overall mechanical behaviour of the model, and these are solved, giving the nodal displacements resulting from the applied loads. For the analysis of bones, finite element analysis is thus dependent upon the density of each element, the arrangement of elements (e.g. trabecular structure), the composition (e.g. cortical or cancellous) and the external shape.

FEA has been applied to computer modelling of bioengineering situations incorporating bone. Studies related to osteoporosis have tended to concentrate on the prediction of femoral fracture risk and to utilise the 3D potential of FEA via incorporation of 3D computed Tomography (CT) data. However, although being more technically advanced than DXA, CT is not suitable for routine utilisation in clinical assessment of fracture risk, being both expensive and administering a high radiation dose. Also DXA machines are usually more readily available than CT machines and so a method which uses DXA data would be more readily applicable.

It is known to produce a finite element model from DXA data and carry out FEA on that model in order to analyse the bone. However, in such simulations, the simulated load is applied at a particular point on the bone model and then as the simulated load is increased, the movement of the model is noted. This is not necessarily an accurate simulation of how a real bone may be loaded in normal life and so does not necessarily give a good prediction of whether or not a particular bone is suffering from osteoporosis and therefore more likely to fracture.

The present invention aims to provide a method and apparatus which reduces some or all of the above problems. Where the term “bone” is used, this term also encompasses a bone portion or bone segment. In addition, the bones referred to could be human or animal bones.

Accordingly, in a first aspect, the present invention provides a method of analysing a bone model, the bone model including an array of finite elements, the method including the steps of:

i. simulating the application of a load to a selected plurality of the elements and

ii. limiting the selected elements so that each moves an equal distance when the load application is simulated.

This more accurately simulates how a load may be applied to a bone in real life and therefore provides a more accurate diagnosis of the presence of osteoporosis.

Preferably the selected plurality of the elements are located at the surface of the bone. In effect, this then simulates the application of the load via a platen where the face of the platen is shaped so as to conform to the contour of the area of bone which it abuts.

Preferably the bone model is a two dimensional model (possibly with a defined depth of a third dimension e.g. a constant depth such as 1 voxcel), although it may also be three dimensional. Some such “two dimensional” models may be termed ‘thin plate’. In some embodiments, the method may also include the step of the creation of this model although in others the model may be created elsewhere and, for example, supplied to an operator for analysis.

A voxel is a three-dimensional pixel e.g. a cube with each face consisting of one pixel.

Alternatively, in some practical situations, one user e.g. a hospital may supply raw data (e.g. DXA data or a digitised radiograph) and an analysis operator then creates the model and carries out the simulation. In either scenario, the transfer from the user to the analysis operator could be e.g. by providing the data in hard copy format (perhaps on paper or on disk) or alternatively the analysis services could be offered via the internet and the data transmitted between parties over the internet.

Where the method includes the step of creating the model, any or all of the following further steps could be used to achieve it:

a) A digital DXA image or BMD/radiograph image is used to produce a bitmap image of the bone to be simulated.

b) The bitmap image could be a black and white image providing, for example, 256 levels of gray scale for each pixel. This equates to an 8 bit bitmap.

c) The gray scale level of each individual pixel within the digitised image is taken to correspond to the apparent areal density of the bone represented by that pixel. Areal density is defined as the mass of bone tissue divided by the cross sectional area of the pixel. In one example of an embodiment of the present invention, the areal density of a pixel may then in turn be related to a volumetric density of the pixel (or, in effect, a voxel). One simple way of doing this is to assume a constant tissue depth (e.g. 40 mm) and to use this assumption to provide the third dimension in the volume calculation. Additionally or alternatively, more refined methods of converting the areal density measurement into an assumed volumetric density value may be used and one example will be given below.

d) Areas of the image which are not wanted may be removed e.g. manually or automatically, possibly using a suitable image editing software program such as PaintShop Pro. The pixels which may be removed could relate, for example, to soft tissue surrounding the bone or to other bones not to be included in the analysis.

e) Using standard techniques the Young's modulus of the bone described by each image pixel is derived from the pixel's gray level. In one example, the conversion of image gray scale (a surrogate for BMD) into Young's modulus for a particular pixel could be facilitated via measurement of a step wedge. There would be a known relationship between (say aluminium) wedge thickness and BMD. Hence, wedge image gray level could be transposed into BMD. BMD (indicated by gray level) would subsequently be converted into Young's modulus using either linear or non-linear regression. The step wedge would be scanned at the same time as the bone to be assessed and would hence provide measurement calibration for variability in X-ray source, photographic film sensitivity etc.

f) The corners of each pixel or voxel are then taken as nodes and a finite element model is created based on those nodes. Alternatively, the centre of each pixel/voxel (or indeed any other suitable point or points) can be taken as nodes and furthermore the stress calculations may be carried out in relation to points other than the nodes, such as Gauss points.

As mentioned in step c) above, the present invention may utilise a different method for deriving the volumetric density of the pixels or voxels from the areal density taken from the gray scale value. Preferably a further model (called a “shape atlas”) may be utilised which predicts likely tissue depth at any given pixel position, rather than assuming a constant tissue depth. Such a model may be particular to a given bone and may for example be derived by measuring a set of real bones and determining a typical average shape which is then modelled.

The finite element bone model created may be a “2 1/2” dimension model (e.g. a 2D model with a depth of 1 or more voxels) or, preferably a 3D model.

In a refinement, the further model (or a different additional model) may include variable density values. In such a case, not only would the model predict the actual tissue depth for a given pixel (i.e. given a location within the bone) but also predict a likely density (and hence Young's modulus) for each voxel along the line of the given pixel.

In preferred embodiments, this is used to create a 3D bone model.

When the simulation is being carried out, the simulation means may also be arranged to constrain other elements. For example one part of the bone (e.g. the edge furthest away from where the load is to be applied) may be restrained, such as in one or both of the vertical and horizontal directions. Preferably the selected elements are constrained to move an equal distance in the same direction.

By dividing the known applied load by the recorded (simulated) displacement (usually in a vertical direction) of the selected elements, the mechanical stiffness of the bone may be derived.

In a further aspect, the method of the present invention may be carried out utilising a software program. For example, the program may be such that a user inputs a DXA image file or a digitised radiograph file and then the finite element model is automatically created and the analysis carried out.

In a further aspect the present invention provides an apparatus including means for carrying out the method. For example, the present invention may provide a bone strength simulation apparatus including:

modelling means for modelling a bone as an array of finite elements, and

simulation means for simulating the application of a load to a selected plurality of the elements,

wherein in use the simulation means constrains the selective elements each to move an equal distance when the load application is simulated.

Other features of the apparatus will be apparent from the preceding description of the method. The apparatus according to the present invention may be, for example, incorporated into a DXA scanner or a radiograph scanner. Alternatively, the apparatus could include a suitably programmed computer.

In any of the above aspects, the invention may additionally or alternatively consist only of the model creation and exclude some or all of the model analysis.

By way of example, embodiments of the present invention will now be described with reference to the accompanying drawings in which:

FIG. 1 is a BMD image of a human forearm.

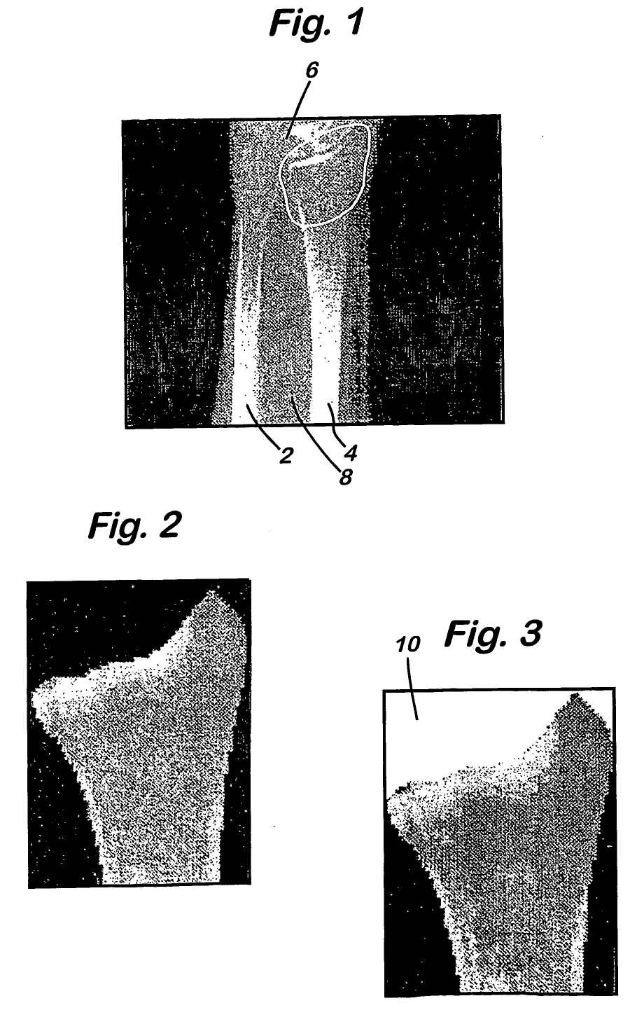

FIG. 2 is a bitmap image of the portion of FIG. 1 which is ringed.

FIG. 3 is a revised version of the bitmap image of FIG. 2.

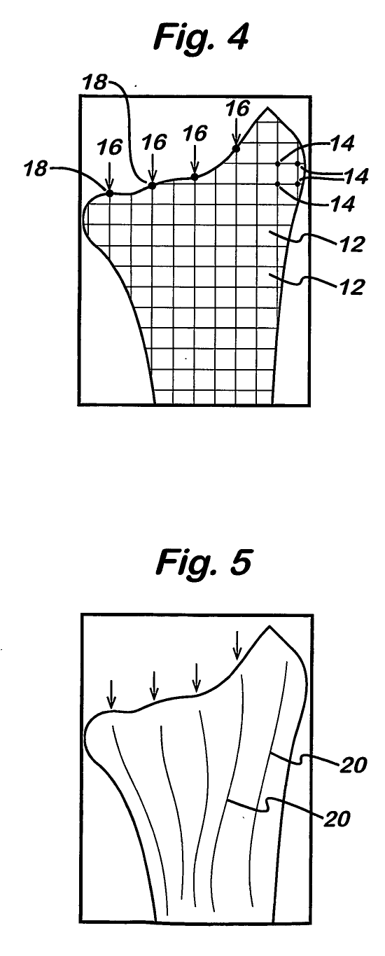

FIG. 4 is a schematic diagram of a finite element model produced from the image of FIG. 3.

FIG. 5 is a schematic diagram showing the model of FIG. 4 after application of a simulated load.

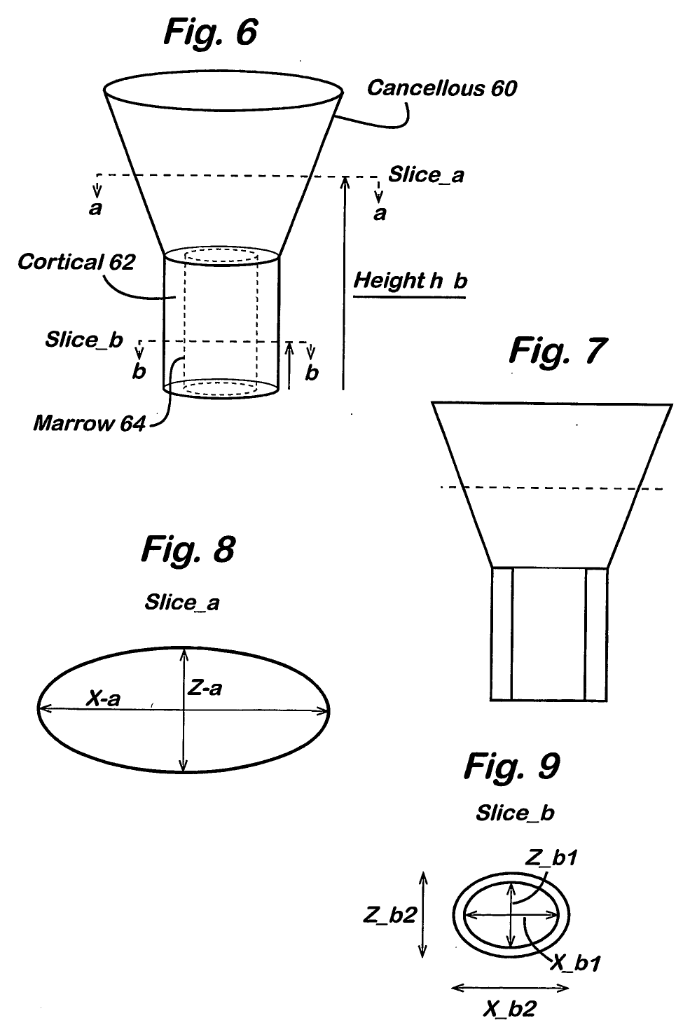

FIG. 6 shows a simplified model of a distal radius bone.

FIG. 7 is a simplified radiograph image of the distal radius of FIG. 6.

FIG. 8 is a cross-sectional view along the line A-A in FIG. 6.

FIG. 9 is a cross-sectional view along the line B-B in FIG. 6.

FIG. 1 is a conventional BMD image of a human forearm. The image clearly shows the ulna bone 2, the radius bone 4 and the wrist bones 6, together with other tissue material 8. In this example, the portion of bone to be analysed is the tip of the radius 4 and this portion of the BMD image is converted into an e.g. 8 bit bitmap (.BMP) format as seen in FIG. 2. The original format for the BMD image may, for example, be TIF format.

The 8 bit bitmap format provides 256 levels of gray scale for each pixel. The gray level of an individual pixel within a digitised BMD image therefore corresponds to the apparent areal density within that pixel, defined as the mass of bone tissue divided by the cross-sectional area of the pixel. The BMD images may be manually modified (e.g. using PaintShop Pro, by JASC Software, of Eden Prairie, USA) to remove pixels beyond the extent of the distal radius, e.g. soft tissue and other bones. In this example, the distal region of the radius, extending a predetermined distance (e.g. 80 pixels) from the tip, was selected. It should be noted that 2D BMD images are representations of 3D anatomy and hence the ‘bone’ portion could include an artefact of overlying soft-tissues and bone.

A computer program e.g. written in MATLAB (by Mathworks, of Natick, Mass., USA), is used to convert the bitmap image of FIG. 2 into a script file suitable for finite element analysis. The FEA can be performed using various commercially available software packages. The Young's modulus of each BMD image pixel is derived from the pixel's gray level. This may be achieved by firstly obtaining the relationship between DXA-derived BMD and image gray level, and secondly by incorporating this into an expression relating Young's modulus and density, thus providing a relationship between Young's modulus (E) and image gray level. In one example, a seven level aluminium step was scanned and analysed on a Lunar Expert in forearm mode. A TIF image of the step wedge was exported into PaintShop Pro from which a regression of BMD against gray level was derived (BMD=0.0049.Gray Level−0.1754, R²=0.9996). An approximately cubic function (E=10\hat{ }(−6.09+3.13.log(BMD)) relating Young's modulus to BMD can then be utilised.

In one example, the bottom horizontal edge (radial shaft) is simulated as being automatically restrained e.g. in both vertical and horizontal directions. Finite element analysis can then be undertaken simulating a mechanical test in which a platen is placed above the bone sample and subsequently loaded. To facilitate evenly distributed loading across the face of the radius, the lower surface of the platen 10 is simulated as being shaped to conform with the curved upper surface of the radius, shown in FIG. 3. By dividing the known applied load by the recorded vertical displacement of the platen, the mechanical stiffness may be derived. The Matlab program may automatically apply the restraints, platen and loading.

FIG. 4 is a schematic diagram showing one example of a finite element model. The model is constructed from a number of pixels 12 which are shown as far larger than they would normally be, for the purposes of illustration. Each pixel 12 has four corners 14 and these are treated as nodes for the purposes of construction of the finite element model. Other nodes may be introduced as necessary.

The platen 10 is represented by a series of forces 16 which, in this example, are applied to nodes 18 which lie on the upper surface of the bone sample. In FIG. 4, the load forces 16 are not applied to every node which lies on the upper surface of the sample, but in other examples this may not be the case, i.e. in order to better simulate a platen 10, the load forces 16 may be applied to every applicable node.

The finite element model and the simulation are arranged so that the nodes 18 are each constrained to move by the same distance and, in this example, in the same direction. This simulates the application of the platen 10. FIG. 5 is a schematic diagram of the bone sample model after the simulated load has been applied, showing the appearance of the stress lines 20. From the stress lines 20, and other factors, a more accurate diagnosis of the condition of the bone and therefore the likelihood of fracture can be obtained.

As mentioned above in relation to FIG. 2, the gray scale level of an individual pixel may be taken to correspond to the apparent areal density within that pixel. By reference to an assumed constant tissue depth (e.g. 40 mm), an area density value may be converted to a volumetric density for a given pixel. Alternatively, a more sophisticated method may be used to convert areal density to volumetric density for a given pixel and this is illustrated in FIGS. 6-9.

FIG. 6 shows an idealised model of a distal radius, including a predominantly cancellous portion 60 and a predominantly cortical portion 62. The cortical portion 62 includes within it a section of marrow 64.

The example model shown in FIG. 6 may be considered to be a “shape atlas” for a distal radius and could, for example be derived by studying a number of real bones. FIG. 7 shows a simplified radiograph image of a distal radius and, from the model shown in FIG. 6, it can be seen that for each pixel of the image of FIG. 7, the corresponding section of bone of FIG. 6 will have a particular depth and, preferably, a particular density distribution. The depths and/or density distribution values may be variable throughout the model of FIG. 6.

FIGS. 8 and 9 show cross-sectional views along the lines A-A and B-B respectively in FIG. 6. As can be seen, in the simplified model of FIG. 6, the bone cross-section is assumed to be substantial elliptical in those sections. However, the model may define any other shape, regular or irregular, depending on the bone or bone portion being modelled.

A model such as illustrated by FIGS. 6, 8 and 9 can then be used in the creation of a 2D or 3D finite element bone model according to one aspect of the invention from e.g. x-ray date, as explained above, for subsequent analysis according to a further aspect of the invention.

This example has been explained with reference to a human distal radius (forearm) but many other bones may be suitable for analysis, such as a human hip (proximal femur), lumbar spine or an equine 3rd metacarpus.

The above embodiments have been given by way of example only and modifications will be apparent to those skilled in the art.

1. A method of analysing a bone model, the bone model including an array of finite elements, the method including the steps of:
i. simulating the application of a load to a selected plurality of the elements and
ii. limiting the selected elements so that each moves an equal distance when the load application is simulated.

2. A method according to claim 1 wherein the selected plurality of the elements are located at the surface of the modelled bone.

3. A method according to claim 1 or claim 2 including the step of the creation of the model.

4. A method according to claim 3 wherein the step of creating the model includes:
a) producing a bitmap image of the bone to be simulated,
b) From the gray scale level of each individual pixel within the bitmap image, calculating the apparent areal density of the bone represented by that pixel,
c) Calculating the Young's modulus of the bone described by each image pixel from the pixel's gray level,
d) Selecting one or more nodes per pixel and creating a finite element model based on those nodes.

5. A method according to claim 4 wherein step (c) includes using comparison of the grayscale levels of the bitmap image with those of a reference image.

6. A method according to claim 5 wherein step b) includes deriving the volumetric density of each pixel from the areal density.

7. A method according to claim 6 wherein a further model of the bone is used to give a value of likely tissue depth at any given pixel position which is then used to calculate the volumetric density from the areal density.

8. A method according to any of the above claim wherein the model is three-dimensional and is created using a further model of the bone and also includes a three-dimensional density distribution for the bone of each pixel.

9. A method according to any of the above claims further including the step of constraining other of the elements.

10. A method according to claim 9 wherein the edge of the modelled bone furthest away from where the load is to be applied is constrained in one or both of the vertical and horizontal directions.

11. A method according to any of the above claims wherein the selected elements are constrained to move an equal distance in the same direction.

12. An apparatus including means for carrying out a method according to any one of the above claims.

13. A bone strength simulation apparatus including:
modelling means for modelling a bone as an array of finite elements, and
simulation means for simulating the application of a load to a selected plurality of the elements,
wherein in use the simulation means constrains the selective elements each to move an equal distance when the load application is simulated.
